(19) United States
(12) Patent Application Publication
(10) Pub. No.: US 2017/0210309 A1
(43) Pub. Date: Jul. 27, 2017

(54) ELECTRICAL EQUIPMENT MODULE

(71) Applicant: Yazaki Corporation, Tokyo (JP)

(72) Inventors: Mitsunori Tsunoda, Shizuoka (JP); Syuji Kimura, Shizuoka (JP); Gaku Itou, Shizuoka (JP); Shoichi Nomura, Shizuoka (JP); Taku Furuta, Shizuoka (JP); Naoya Yamashita, Shizuoka (JP)

(21) Appl. No.: 15/408,020

(22) Filed: Jan. 17, 2017

(30) Foreign Application Priority Data
Jan. 21, 2016 (JP) 2016-010077

(51) Int. Cl. B60R 16/03; B60R 16/023

(52) U.S. Cl. CPC B60R 16/03; B60R 16/0238

(57) ABSTRACT

An electrical equipment module includes: a main line module that includes a width direction extending member mounted in a vehicle and extending along the vehicle width direction of the vehicle, and a mounting main line section provided in the width direction extending member and including a circuit body mounted with an electronic component; and a submodule that is connected to the main line module and to which power is distributed via the circuit body. With this configuration, the electrical equipment module allows the work of main line routing or the like to be reduced and mounting work to be made more efficient, thereby improving the mountability to the vehicle.

### CROSS-REFERENCE TO RELATED APPLICATION(S)

The present application claims priority to and incorporates by reference the entire contents of Japanese Patent Application No. 2016-010077 filed in Japan on Jan. 21, 2016.

### BACKGROUND OF THE INVENTION

1. Field of the Invention

The present invention relates to an electrical equipment module.

2. Description of the Related Art

As a conventional electrical equipment module applied to vehicles, for example, Japanese Patent Application Laid-open No. 2003-146150 discloses an instrument panel wire harness device that includes: an instrument panel wire harness arranged in an instrument panel and having a standard circuit having no effect on vehicle grade and variation and a standard multipoint connection section; and a plurality of submodules connected to the instrument panel wire harness and having a branch line harness routed according to vehicle grade and variation and routed and terminated.

The instrument panel wire harness device described in Japanese Patent Application Laid-open No. 2003-146150 still has some room for improvement, for example, in mountability.

### SUMMARY OF THE INVENTION

In view of the above-described circumstances, an object of the present invention is to provide an electrical equipment module capable of improving mountability into vehicles.

In order to achieve the above mentioned object, an electrical equipment module according to one aspect of the present invention includes a main line module that includes a width direction extending member mounted in a vehicle and extending along a vehicle width direction of the vehicle, and a mounting main line section provided in the width direction extending member and including a circuit body mounted with an electronic component; and a submodule that is connected to the main line module and to which power is distributed via the circuit body.

According to another aspect of the present invention, in the electrical equipment module, it is possible to configure that the width direction extending member is configured with an air-conditioning duct that has a hollow shape and inside which air is allowed to be circulated.

According to still another aspect of the present invention, in the electrical equipment module, it is possible to configure that the width direction extending member is configured with a support member for supporting an interior member of the vehicle.

According to still another aspect of the present invention, in the electrical equipment module, it is possible to configure that the width direction extending member is configured with a back plane bus base formed of a resin material.

According to still another aspect of the present invention, in the electrical equipment module, it is possible to configure that the circuit body includes a printed circuit body printed on a surface of the width direction extending member.

According to still another aspect of the present invention, in the electrical equipment module, it is possible to further include that a communication control connector configured to electrically connect the submodule and the mounting main line section, to perform communication between the submodule and the mounting main line section, and to control a device included in the submodule.

According to still another aspect of the present invention, in the electrical equipment module, it is possible to configure that the electronic component includes at least one of a connection functional component for connection to the submodule, a power supply distribution functional component for distributing power to the submodule, a control functional component for controlling a device mounted in the vehicle, a power supply backup functional component for backing up a power supply mounted in the vehicle, and a wireless communication functional component for performing wireless communication.

According to still another aspect of the present invention, in the electrical equipment module, it is possible to configure that the main line module is arranged inside an instrument panel of the vehicle, and the submodule includes an instrument panel display module having a display configured to cover the instrument panel and be capable of visually displaying information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic configuration of an electrical equipment module according to a first embodiment;

FIG. 2 is a partial perspective view of the interior of a vehicle to which the electrical equipment module according to the first embodiment is applied;

FIG. 3 is a partial perspective view of the interior of the vehicle to which the electrical equipment module according to the first embodiment is applied;

FIG. 4 is a schematic partial cross-sectional view of the vehicle to which the electrical equipment module according to the first embodiment is applied;

FIG. 5 is a partial perspective view of the interior of a vehicle to which an electrical equipment module according to a second embodiment is applied;

FIG. 6 is a perspective view of a storage medium card for function expansion and a reading slot that are applicable to the electrical equipment module according to the second embodiment;

FIG. 7 is a schematic partial perspective view of a connection structure section applicable to the electrical equipment module according to the second embodiment;

FIG. 8 is a schematic cross-sectional view of the connection structure section applicable to the electrical equipment module according to the second embodiment;

FIG. 9 is a partial perspective view including a standby connector applied to the electrical equipment module according to the second embodiment;

FIG. 10 is a partial perspective view including the standby connector applied to the electrical equipment module according to the second embodiment;

FIG. 11 is a schematic cross-sectional view including a fixing clamp of an electrical equipment module according to a modification; and

FIG. 12 is a schematic cross-sectional view including a rear cover of the electrical equipment module according to the modification.

### DETAILED DESCRIPTION OF THE PREFERRED EMBODIMENTS

Embodiments according to the present invention will be described below in detail based on the drawings. It should be noted that the invention is not limited by the embodiments. Besides, constituent elements in the following embodiments include those replaceable and easy to conceive by persons skilled in the art, or those substantially equivalent thereto.

### First Embodiment

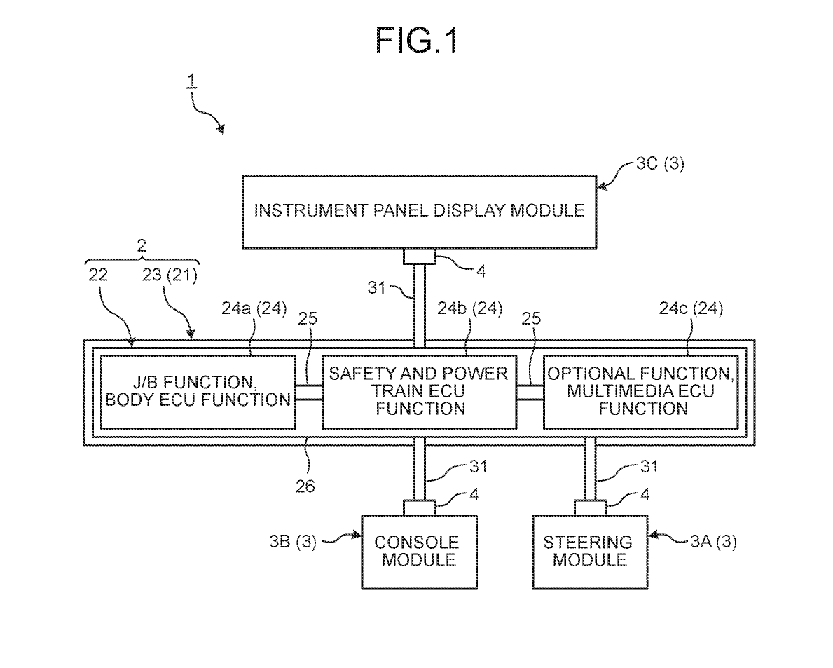

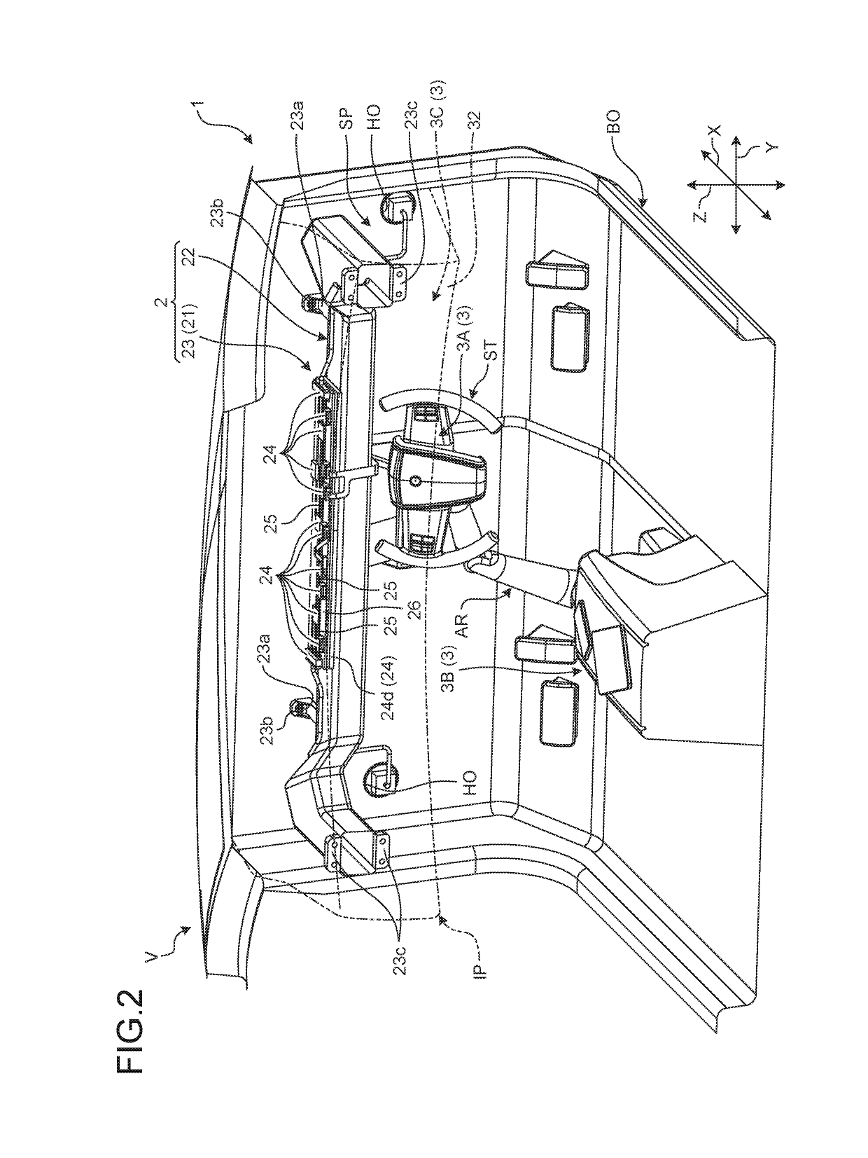

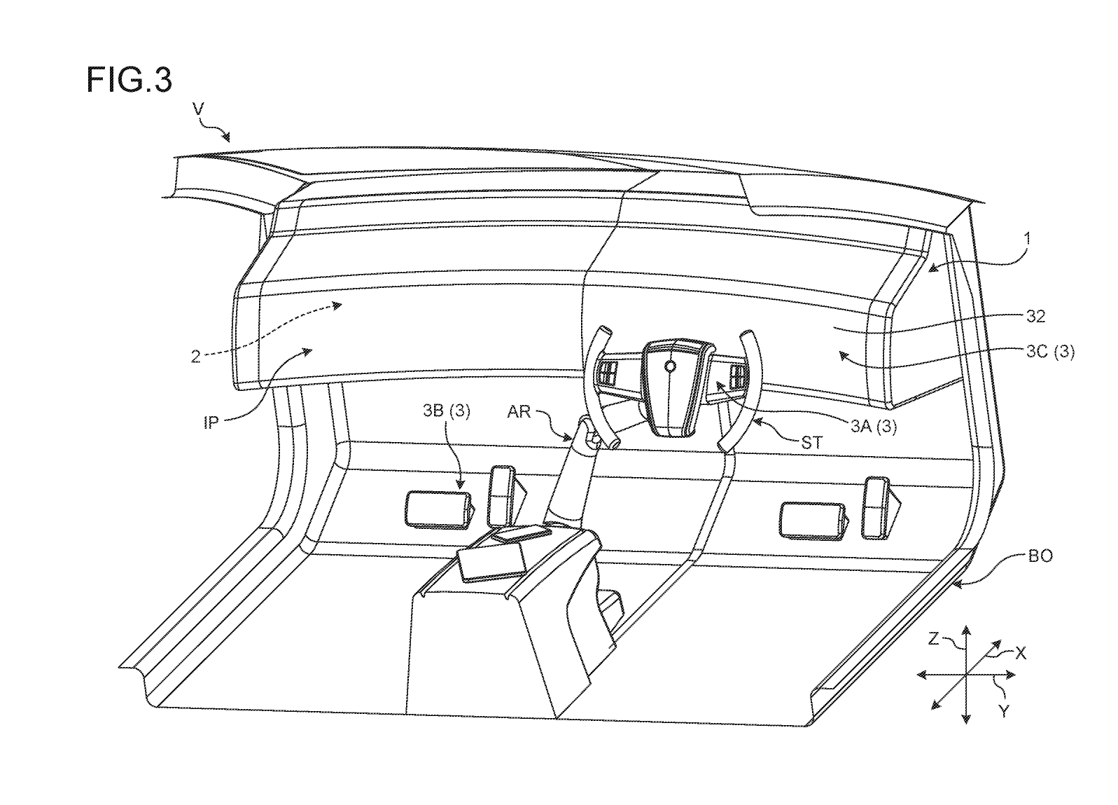

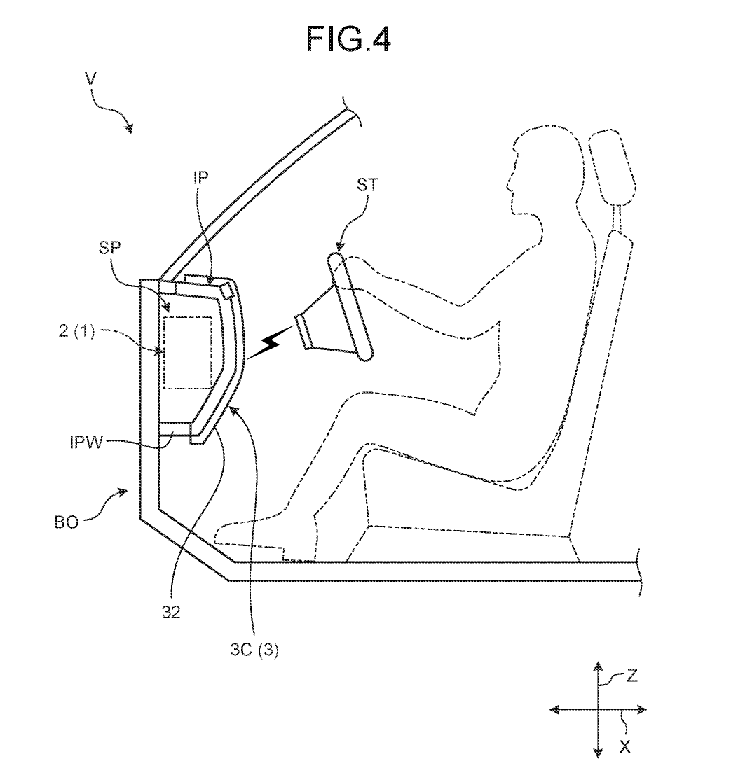

FIG. 1 is a block diagram illustrating a schematic configuration of an electrical equipment module according to a first embodiment. FIG. 2 and FIG. 3 are partial perspective views of the interior of a vehicle to which the electrical equipment module according to the first embodiment is applied. FIG. 4 is a schematic partial cross-sectional view of the vehicle to which the electrical equipment module according to the first embodiment is applied. Incidentally, FIG. 2 illustrates an instrument panel with an alternate long and two short dashes line to make a main line module of the electrical equipment module easier to understand.

The electrical equipment module 1 according to the present embodiment illustrated in FIG. 1, FIG. 2, FIG. 3, and FIG. 4 is applied to a vehicle V, and connects between devices mounted in the vehicle V, and is used for power supply and signal communication. The electrical equipment module 1 according to the present embodiment is a typical instrument panel module in which a later-described main line module 2 is arranged inside an instrument panel IP of the vehicle V along a vehicle width direction Y. The instrument panel IP is a member provided along the vehicle width direction Y on the interior side of the vehicle V and the front side in a vehicle longitudinal direction X. In other words, the electrical equipment module 1 serving as an instrument panel module is a structural module in which a main line module 2 is provided along the vehicle width direction Y on the interior side of the vehicle V and the front side in the vehicle longitudinal direction X. More specifically, in the electrical equipment module 1, the main line module 2 is arranged inside an accommodation space section SP (refer to FIG. 2 and FIG. 4) enclosed by the instrument panel IP and a wall surface of a body BO of the vehicle V on the front side in the vehicle longitudinal direction X.

Here, in the vehicle V to which the electrical equipment module 1 is applied, the “vehicle longitudinal direction X” typically corresponds to the length direction of the vehicle V, and more specifically, corresponds to a direction along the forward and backward movement direction of the vehicle V. The “vehicle width direction Y” typically corresponds to the width direction of the vehicle V, and more specifically, corresponds to the vehicle right and left direction of the vehicle V. The “vehicle height direction Z” typically corresponds to the vehicle height direction of the vehicle V. The vehicle longitudinal direction X serving as a first direction, the vehicle width direction Y serving as a second direction, and the vehicle height direction Z serving as a third direction intersect one another at right angles, and in a state in which the vehicle V is located in a horizontal plane, the vehicle longitudinal direction X and the vehicle width direction Y are along the horizontal direction, and the vehicle height direction Z is along the vertical direction. Furthermore, in the following description, in the vehicle longitudinal direction X, a side to which the vehicle V moves forward and a side to which the vehicle V moves backward are sometimes expressed as “forward” and “backward”, respectively. In the vehicle width direction Y, the left side when facing forward in the vehicle longitudinal direction X (the left side in FIG. 2) and the right side when facing forward in the vehicle longitudinal direction X (the right side in FIG. 2) are sometimes expressed as “left side” and “right side”, respectively. In the vehicle height direction Z, the upper side in the vertical direction and the lower side in the vertical direction are sometimes expressed as “upper side” and “lower side”, respectively. Unless otherwise specified, directions used in the following description represent directions in a state in which sections are mounted to each other.

There will be described, as an example, a case in which the vehicle V adopting the electrical equipment module 1 according to the present embodiment is a vehicle capable of automatic driving that is advanced enough not to require steering operation by a driver. In the description herein, the vehicle V is considered as a non-reinforced vehicle that is not equipped with a structural reinforcing member, what is called a reinforcement, extending along the vehicle width direction Y inside the instrument panel IP and supporting a steering ST on the body BO. For example, the vehicle V has what is called a steering-by-wire system in which steering ST has no mechanical connection with steering wheels, and the steering ST is supported on the floor of the body BO by a support arm AR. The vehicle V may be configured such that, for example, the steering ST is allowed to be accommodated in a predetermined accommodation position together with various pedals at the time of, for example, automatic driving, which does not require operations by a driver. It should be noted that, in the description herein, the electrical equipment module 1 is applied to a non-reinforced vehicle V, but not limited to this, and may be applied to a vehicle having a reinforcement.

The electrical equipment module 1 according to the present embodiment is configured such that, after various kinds of electronic components 24 are mounted in a main line module 2 extending along the vehicle width direction Y inside the instrument panel IP, various kinds of submodules 3 are connected to the main line module 2 so as to improve mountability into the vehicle V. Hereinafter, the configuration of the electrical equipment module 1 will be described in detail with reference to the drawings.

Specifically, the electrical equipment module 1 includes a main line module 2, a submodule 3, and a communication control connector 4. The main line module 2 is an in-instrument-panel structural module extending along the vehicle width direction Y inside an instrument panel IP, more specifically, inside an accommodation space section SP. The main line module 2 includes a width direction extending member 21 and a mounting main line section 22 provided in the width direction extending member 21.

The width direction extending member 21 is a member mounted in the vehicle V and extending along the vehicle width direction Y inside the instrument panel IP, more specifically, inside the accommodation space section SP. The width direction extending member 21 according to the present embodiment is configured with an air-conditioning duct 23 that has a hollow shape and inside which air is allowed to be circulated (refer to FIG. 2 and other drawings). The air-conditioning duct 23 is formed of, for example, a resin material so as to have the shape of a rectangular hollow pipe, and air for air-conditioning is allowed to be circulated thereinside. The air-conditioning duct 23 has a plurality of fixing brackets 23a in the middle portion thereof, and the fixing brackets 23a are fixed by bolts 23b or other components to the wall surface of the body BO on the front side in the vehicle longitudinal direction X. The air-conditioning duct 23 extends inside the instrument panel IP from the right end to the left end thereof along the vehicle width direction Y in a state in which each of the fixing brackets 23a is fixed to the body BO. Here, the air-conditioning duct 23 constituting the width direction extending member 21 doubles as an instrument panel frame serving as a support member for the instrument panel IP. The air-conditioning duct 23 doubling as the instrument panel frame supports on the body BO the instrument panel IP serving as an interior material of the vehicle V. Here, the air-conditioning duct 23 has support brackets 23c at both ends thereof in the vehicle width direction Y, and the instrument panel IP is fixed to the support brackets 23c by bolts or other components (not illustrated).

The mounting main line section 22 is provided in the width direction extending member 21, has a circuit body 25 on which the electronic components 24 are mounted, and is connected to the later-described submodule 3. The mounting main line section 22 according to the present embodiment is configured separately from the air-conditioning duct 23 constituting the width direction extending member 21, and placed on the upper surface of the air-conditioning duct 23 in the vehicle height direction Z. Here, the mounting main line section 22 has a substrate 26 placed on the upper surface of the air-conditioning duct 23 in the vehicle height direction Z, and the circuit body 25 is provided on the substrate 26, and the electronic components 24 are mounted so as to be connected to the circuit body 25, whereby the mounting main line section 22 becomes a substrate as a whole. As the mounting main line section 22, use may be made of what is called a printed circuit board (PCB) obtained in such a manner that, on the surface (mounting surface) of a substrate 26 formed of an insulating resin material, such as epoxy resin, glass epoxy resin, paper epoxy resin, or ceramic, a wiring pattern (print pattern) serving as the circuit body 25 is printed by a conductive material such as copper to be a printed circuit body; or use may be made of a busbar plate obtained in such a manner that a busbar serving as a circuit body 25 formed of a conductive metal material is coated with an insulating resin material to form a substrate 26. The circuit body 25 constitutes a circuit that electrically connects a plurality of the electronic components 24 and has a required function. In the embodiment illustrated in FIG. 1 and FIG. 2, the circuit body 25 is a printed circuit body printed on the surface of the substrate 26, and is mounted with the electronic components 24 by through holes, for example. The substrate 26 is formed to have an approximately rectangular plate shape, and extends along the vehicle width direction Y on the upper surface of the air-conditioning duct 23. The substrate 26 may be a substrate formed by laminating a plurality of insulating layers on which the circuit body 25 is printed to be multilayered (namely, a multilayer substrate), or may be a substrate on both sides of which the circuit bodies 25 are provided and in which the electronic components 24 are mounted.

The mounting main line section 22 is configured with the electronic components 24, the circuit body 25, and the substrate 26 so as to become a substrate as a whole, having an integral structure into which a function as a main line connected to the submodules 3, a function of distributing power to the submodules 3 connected to the main line, and other functions are integrated. That is, it can be said that the mounting main line section 22 is configured such that the functions of what is called an electrical connection box, such as a junction block, a fuse box, or a relay box, for distributing electric power supplied from a power source to various devices connected to the mounting main line section 22 are incorporated into a main line. Furthermore, the mounting main line section 22 may be configured with the electronic components 24, the circuit body 25, and the substrate 26 so as to become a substrate as a whole, having an integral structure into which functions as various electronic control units (ECUs) serving as control sections for controlling devices mounted in the vehicle V, a power supply backup function of backing up a power supply mounted in the vehicle V, for example, a generator such as an alternator and a battery, a function of performing wireless communications, and other functions are incorporated. That is, it can be said that the mounting main line section 22 is an electronic component unit configured such that, using the electronic components 24, the circuit body 25, and the substrate 26, a main line connected with the submodules 3 is made into a substrate, thereby having no wire harness (no electric wire), and, into the main line in the form of a substrate, various functions, such as power supply distribution, control of various sections, power supply backup, and wireless communications, are integrated.

The electronic components 24 mounted in the mounting main line section 22 are various elements for performing the above-described various functions, and including various functional components. The electronic components 24 include at least one of a connection functional component for connection to the submodule 3 and other devices, a power supply distribution functional component for distributing power to the submodule 3, a control functional component for controlling devices mounted in the vehicle V, a power supply backup functional component for backing up a power supply mounted in the vehicle V, and a wireless communication functional component for performing wireless communications. Examples of the connection functional component include various types of connectors, and external connection units such as an I/O port. Examples of the power supply distribution functional component include a relay, a fuse, a resistor, a transistor, intelligent power switch (IPS), and a power supply control box obtained by unitizing these. Examples of the control functional component include electronic control units, and an ECU, including a microcomputer. The power supply backup functional component is, in other words, a distributed power supply functional component, such as a condenser, a capacitor, a secondary battery unit, or a sheet-type thin battery. Examples of the wireless communication functional component include an antenna, and transmission and reception units having various systems, for example, near field communication (NFC), such as W-LAN, Wifi (registered trademark), and Bluetooth (registered trademark). The antenna may receive ETC, GPS, TEL, or VICS (registered trademark) information. Furthermore, the antenna may be configured, for example, by forming an antenna pattern on the circuit body 25 printed as a printed circuit body on the surface of the substrate 26. This allows the number of constituent components to be reduced. Furthermore, the antenna may be configured, for example, by unitizing a casing and an antenna body in the case where the circuit body 25 is mounted in a region in which the circuit body 25 is hard to print as a printed circuit body.

In the embodiment illustrated in FIG. 1, the electronic components 24 mounted in the mounting main line section 22 include, for example, a functional component 24a for performing a power supply distribution function such as junction block (J/B) and a body ECU function as standard functions, a functional component 24b for performing a safety and power train ECU function as a standard function, and a functional component 24c for performing an optional function allowed to be added as an additional function according to a vehicle type or the like, and a multimedia ECU function. Furthermore, as illustrated in FIG. 2, the electronic components 24 mounted in the mounting main line section 22 may include a sheet-type thin battery 24d as a power supply backup functional component. Here, the sheet-type thin battery 24d is formed to have an approximately rectangular plate shape, and provided between the upper surface of the air-conditioning duct 23 and the substrate 26 of the mounting main line section 22. For example, the use of the sheet-like battery 24d as a backup power supply at the time of automatic driving allows an improvement in the safety of the vehicle V.

Incidentally, the mounting main line section 22 constituting the main line module 2 may be electrically connected to other vehicle-mounted modules in an engine compartment located outside a cabin across the wall surface of the body BO on the front side in the vehicle longitudinal direction X from the cabin. In this case, as illustrated in FIG. 2, the mounting main line section 22 is sometimes electrically connected to other vehicle-mounted modules in the engine compartment via a connector or an electric wire fitted into a through hole HO formed in the wall surface of the body BO on the front side in the vehicle longitudinal direction X. At this time, there is a risk that, in the vehicle V, noise in the engine compartment leaks out to the inside of the cabin through the through hole HO allowing a communication between a space including the engine compartment outside the cabin and a space including the instrument panel IP inside the cabin, whereby silence inside the cabin could be lost. By contrast, in the electrical equipment module 1 according to the present embodiment, a through hole HO serving as a connection opening to other vehicle-mounted modules in the engine compartment is provided in the accommodation space section SP and formed at a position surrounded with the instrument panel IP. Thus, the electrical equipment module 1 allows the instrument panel IP itself to function as a noise barrier for insulation of leakage noise. This allows the electrical equipment module 1 to prevent the loss of silence inside the cabin without providing a relatively complicated structure such as a grommet structure or soundproofing treatment using a dash silencer, and to achieve a reduction in manufacturing costs and a reduction in the loss of silence inside the cabin.

The submodule 3 is configured such that various devices are electrically connected via a routing circuit body such as an electric wire or a busbar and modularized to form a high-density and high-efficient circuit according to an arrangement area in the vehicle V. The submodule 3 is connected to the main line module 2, whereby power is distributed to the submodule 3 via at least the circuit body 25 of the mounting main line section 22. The submodule 3 is connected to the mounting main line section 22, whereby power supply and signal communications between the submodule 3 and various devices are performed via the electronic components 24 and the circuit body 25. The submodule 3 is typically connected to the connection functional component mounted as an electronic component 24 in the mounting main line section 22 via a connector (for example, the later-described communication control connector 4) or a routing circuit body 31 (refer to FIG. 1) such as an electric wire or a busbar, whereby power supply and signal communications are performed. It should be noted that the submodule 3 is not limited to the above, and may be directly connected to the above-mentioned connection functional component without the use of the routing circuit body 31. The submodule 3 may perform some of the signal communications by various types of wireless communications via the wireless communication functional component mounted as an electronic component 24 in the mounting main line section 22. The submodule 3 may be supplied with power by various types of non-contact power supply. The submodule 3 may be configured such that various devices in the submodule 3 are wire-connected by a routing circuit body, such as an electric wire or a busbar, or may be connected by making use of various types of wireless communications. Here, a plurality of the submodules 3 is provided. In the embodiment illustrated in FIG. 1, FIG. 2, and FIG. 3, there are provided three submodules 3 in total, namely, a steering module 3A, a console module 3B, and an instrument panel display module 3C.

The steering module 3A includes various devices, such as various switches provided in the steering ST and operating audios, multimedia, and air conditioning equipment, and various sensors for detecting, for example, steering angle of the steering ST. The steering module 3A is connected to the connection functional component mounted as an electronic component 24 in the mounting main line section 22 to perform power supply and signal communications. The steering module 3A may perform some of the signal communications by various types of wireless communications via the wireless communication functional component mounted as an electronic component 24 in the mounting main line section 22.

The console module 3B includes various devices, such as a connection device to external devices, such as 100V receptacle, 12V socket, USB socket, and HDMI (registered trademark) socket. Furthermore, the console module 3B may include various devices, such as various types of transmission and reception units capable of wireless communications with various types of non-contact power supply devices capable of contactless-charging drag-in terminal devices, such as smart phones, tablets, and game machines, and wireless communications with such drag-in terminal devices. The console module 3B is connected to the connection functional component mounted as an electronic component 24 in the mounting main line section 22 to perform power supply and signal communications. The console module 3B may perform some of the signal communications by various types of wireless communications via the wireless communication functional component mounted as an electronic component 24 in the mounting main line section 22.

The instrument panel display module 3C includes various devices, such as a display 32 configured to cover the instrument panel IP and allow a visual display of information (refer to FIG. 3 and FIG. 4). In the description herein, the display 32 is provided so as to cover the approximate entirety of the instrument panel IP in a range visible from a driver's seat or the like, but is not limited to this. As the display 32, use may be made of, for example, a thin-type liquid crystal display, a plasma display, or an organic EL display, thereby allowing various images to be displayed. The display 32 is fixed to a surface of the instrument panel IP on the driver's seat side (that is, a surface thereof on the rear side in the vehicle longitudinal direction X), and supported on the air-conditioning duct 23 constituting the width direction extending member 21 via the instrument panel IP. In other words, the air-conditioning duct 23 constituting the width direction extending member 21 doubles as a display frame serving as a support member for supporting the display 32 on the body BO via the instrument panel IP. The display 32 may produce a visual display of information on the vehicle V, for example, various driving information that varies every moment at the time of driving the vehicle V, such as the velocity of the vehicle V, the accumulated travel distance thereof, cooling water temperature, the output rotating speed of a power source for driving, the amount of remaining fuel, the amount of electricity storage in battery, warning information (what is called telltale), shift position indicator, and eco-driving. The display 32 may be provided so as to be superimposed on a touch panel, and configured such that images of various operation switches are displayed at optimal positions according to the circumstances, and the images of the operation switches are selectable by the touch panel. The display 32 may be configured such that, for example, image display contents may be suitably changed according to whether manual driving by a driver or automatic driving without driver's operation, and image display contents may be changed to arbitrary ones according to operation of a user such as a driver. At the time of automatic driving without driver's operation, the display 32 may provide a visual display of, for example, movies or scenery images, or may provide a visual display of images linked to the above-described carry-in terminal device. The display 32 may automatically change image display contents successively according to, for example, the time-of-day and changes in environments and living body information of a driver or others that are detected by various sensors. For example, the display 32 may change image display contents according to the surface temperature of the instrument panel IP and ambient temperature detected by a thermistor, and may display warning images against extreme driving according to, for example, acceleration detected by an acceleration sensor. The instrument panel display module 3C is connected to the connection functional component mounted as an electronic component 24 in the mounting main line section 22 to perform power supply and signal communications. The instrument panel display module 3C may perform some of the signal communications by various types of wireless communications via the wireless communication functional component mounted as an electronic component 24 in the mounting main line section 22. For example, in terms of a positional relation, the main line module 2 is located in the vicinity of the display 32 on the back side of the display 32, and therefore, if a control driver or another component is directly connected to the connection functional component of the main line module 2, inter-connecting wiring can be omitted.

Incidentally, in the instrument panel display module 3C, an antenna for receiving, for example, ETC, GPS, TEL, or VICS (registered trademark) information may be configured by forming an antenna pattern in a printed circuit body printed on the surface of the display 32. The instrument panel display module 3C including the antenna may be connected to the main line module 2. In the description above, this electrical equipment module 1 is configured such that the display 32 constituting the instrument panel IP is provided so as to cover the approximate entirety of the instrument panel IP in a range visible from a driver's seat or the like. However, in this case, in a region of the instrument panel IP which region is not provided with the display 32, for example, in a lower end portion of the instrument panel IP in the vehicle height direction Z, an opening-and-closing section for work IPW (refer to FIG. 4) may be provided in a range invisible from a driver's seat or the like. The electrical equipment module 1 may have a configuration that allows the replacement of an electronic component 24 such as a fuse mounted in the mounting main line section 22 via the opening-and-closing section IPW. Furthermore, the electrical equipment module 1 may have a configuration in which what is called an on-board diagnostics (OBD) device and a terminal device for software update for various devices are connected to the connection functional component mounted as an electronic component 24 in the mounting main line section 22 via the opening-and-closing section IPW, whereby on-board diagnostics, software update, and specification update are allowed. This electrical equipment module 1 may have a configuration in which wireless communications with an on-board diagnostics device and a terminal device for software update via the wireless communication functional component mounted as an electronic component 24 in the mounting main line section 22 are performed, whereby on-board diagnostics, software update, and specification update are allowed.

The communication control connector 4 is a connection functional component for electrically connecting the submodule 3 and the mounting main line section 22 of the main line module 2. More specifically, the communication control connector 4 electrically connects the submodule 3 and the mounting main line section 22 of the main line module 2 to perform communications between the submodule 3 and the mounting main line section 22 of the main line module 2 and to control devices included in the submodule 3. As illustrated in FIG. 1, in the case where the submodule 3 is configured to be connected to the mounting main line section 22 via the routing circuit body 31, the communication control connector 4 is configured as a connection functional component for connecting the routing circuit body 31 and the submodule 3, and provided in a connection portion between the submodule 3 and the routing circuit body 31. In the case where the submodule 3 is configured to be directly connected to a connection functional component mounted as an electronic component 24 in the mounting main line section 22 without the use of the routing circuit body 31, the communication control connector 4 is configured as a connection functional component that connects the connection functional component of the mounting main line section 22 and the submodule 3, and provided in a connection portion between the connection functional component of the mounting main line section 22 and the submodule 3. The communication control connector 4 includes, for example, a connection terminal for connecting the routing circuit body 31 or the connection functional component of the mounting main line section 22 and the submodule 3, and a housing for holding the connection terminal. Furthermore, an electronic control unit including various microcomputers for control, and a control functional component such as an ECU are incorporated into the housing. The communication control connector 4 is capable of interactively communicating with the electronic component 24 mounted in the mounting main line section 22 via the control functional component, and performs communications between the submodule 3 and the mounting main line section 22 and controls devices included in the submodule 3.

The above-described electrical equipment module 1 includes: the main line module 2 having the width direction extending member 21 mounted in a vehicle V and extending along the vehicle width direction Y of the vehicle V, and the mounting main line section 22 provided in the width direction extending member 21 and including the circuit body 25 mounted with the electronic components 24; and the submodule 3 that is connected to the main line module 2 and to which power is distributed via the circuit body 25.

Thus, in the electrical equipment module 1, the main line module 2 is configured by providing the width direction extending member 21 with the mounting main line section 22 having an integral structure obtained by integrating a function as a main line connected to the submodule 3 and a function of power supply distribution, by the electronic components 24 and the circuit body 25. The main line module 2 and the submodule 3 are mounted to the vehicle V and connected to each other, whereby the electrical equipment module 1 can be mounted to the vehicle V. As a result, the electrical equipment module 1 allows the work of main line routing or the like to be reduced and mounting work to be made more efficient, thereby improving the mountability to the vehicle V. Furthermore, in the electrical equipment module 1, various electronic components 24 are mounted on the mounting main line section 22 of the main line module 2, whereby the main line module 2 has a simplified form and a more compact and space-saving configuration, and thus, the workability of assembly can be improved and the number of constituent components can be reduced, whereby manufacturing efficiency can be improved.

Furthermore, in the foregoing electrical equipment module 1, the width direction extending member 21 is configured with the air-conditioning duct 23 that has a hollow shape and inside which air is allowed to be circulated. Thus, in the electrical equipment module 1, the provision of the mounting main line section 22 to the air-conditioning duct 23 configured as the width direction extending member 21 allows the main line module 2 to be configured by making use of the air-conditioning duct 23, which is a structure typically mounted to the vehicle V, and accordingly, the number of constituent components can be reduced. Thus, the electrical equipment module 1 allows, for example, a further improvement in the mountability to the vehicle V and a reduction in manufacturing costs.

Furthermore, in the foregoing electrical equipment module 1, the width direction extending member 21 is configured with the air-conditioning duct 23 doubling as a support member for supporting the instrument panel IP serving as the interior member of the vehicle V. Thus, in the electrical equipment module 1, the provision of the mounting main line section 22 to the air-conditioning duct 23 configured as the width direction extending member 21 allows the main line module 2 to be configured by making use of the air-conditioning duct 23 doubling as a support member for supporting the instrument panel IP, and accordingly, the number of constituent components can be reduced. In other words, this electrical equipment module 1 allows one member to perform all of the functions of the air-conditioning duct 23, a support member of the instrument panel IP, and the width direction extending member 21. Accordingly, also in terms of this, the number of constituent components can be reduced. Thus, the electrical equipment module 1 allows, for example, a further improvement in the mountability to the vehicle V and a reduction in manufacturing costs.

Furthermore, the foregoing electrical equipment module 1 includes the communication control connector 4 configured to electrically connect the submodule 3 and the mounting main line section 22, perform communication between the submodule 3 and the mounting main line section 22, and control devices included in the submodule 3. Thus, the electrical equipment module 1 allows communication between the submodule 3 and the mounting main line section 22 and the control of the devices included in the submodule 3 to be integrally performed by the communication control connector 4 without individually connecting the devices included in the submodule 3 to the mounting main line section 22. Accordingly, the work of routing or the like can be further reduced and the mountability to the vehicle V can be further improved.

Furthermore, in the foregoing electrical equipment module 1, the electronic components 24 include at least one of a connection functional component for connection to the submodule 3, a power supply distribution functional component for distributing power to the submodule 3, a control functional component for controlling devices mounted in the vehicle V, a power supply backup functional component for backing up a power supply mounted in the vehicle V, and a wireless communication functional component for performing wireless communication. Thus, the electrical equipment module 1 allows the main line module 2 to be configured with the mounting main line section 22 in which, by the electronic components 24 and the circuit body 25, there are integrated various functions such as the function of a main line to which the submodule 3 is connected and the function of power supply distribution, in addition, the function of controlling devices mounted in the vehicle V, the power supply backup function, and the wireless communication function. Therefore, the mounting of components related to these functions to the vehicle V can be collectively carried out by mounting the main line module 2 to the vehicle V. As a result, the mountability of the electrical equipment module 1 into the vehicle V can be further improved.

Furthermore, in the foregoing electrical equipment module 1, the main line module 2 is arranged inside the instrument panel IP of the vehicle V, and the submodule 3 includes the instrument panel display module 3C having a display 32 configured to cover the instrument panel IP and be capable of a visual display of information. Thus, the electrical equipment module 1 can visually display various information via the display 32 configured to cover the instrument panel IP, and in addition, the mountability of the electrical equipment module 1 including the instrument panel display module 3C to the vehicle V can be improved.

### Second Embodiment

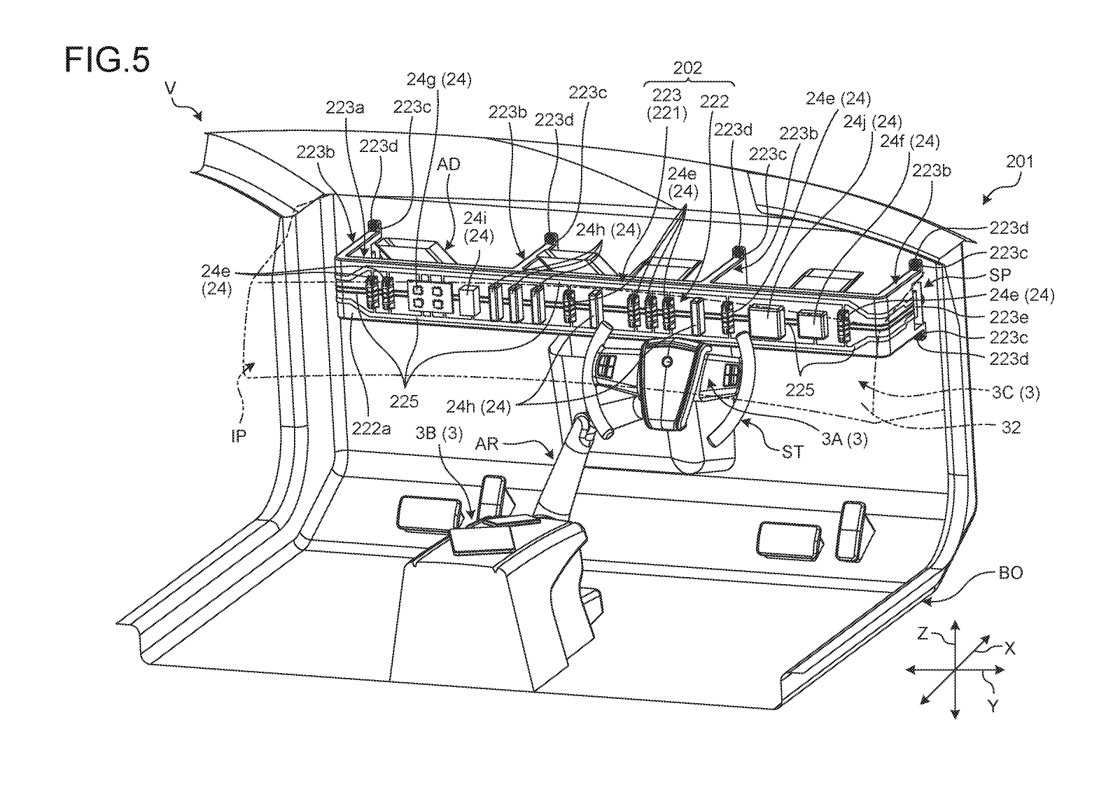

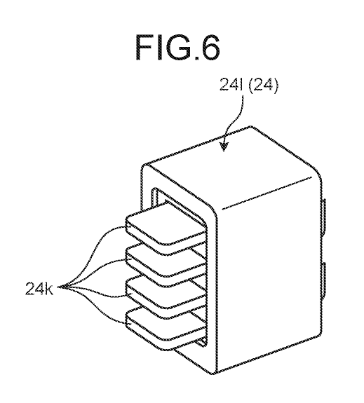

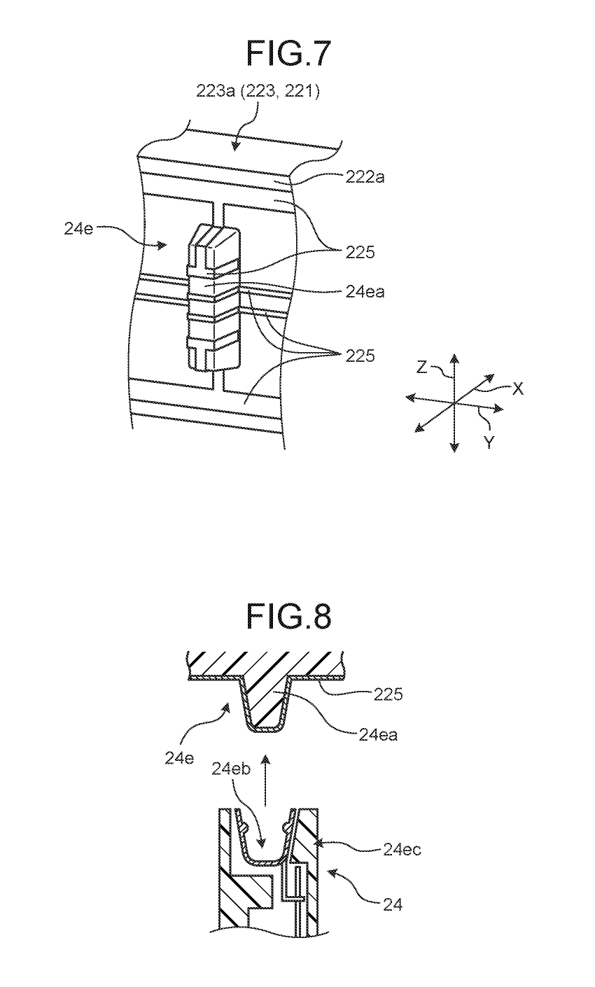

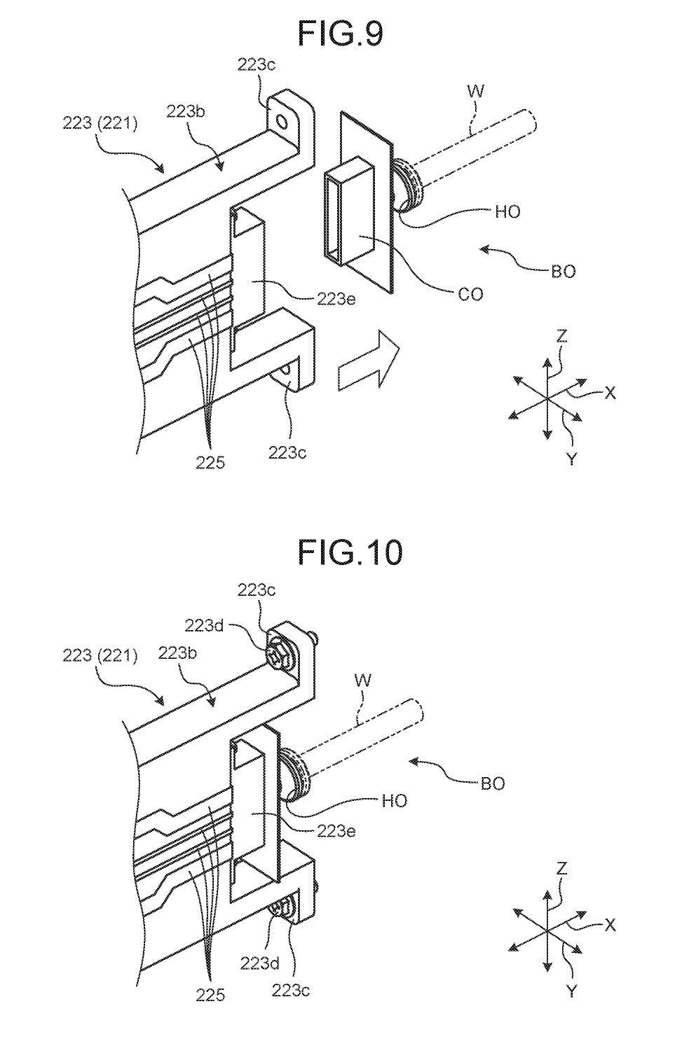

FIG. 5 is a partial perspective view of the interior of a vehicle to which an electrical equipment module according to a second embodiment is applied. FIG. 6 is a perspective view of a storage medium card for function expansion and a reading slot that are applicable to the electrical equipment module according to the second embodiment. FIG. 7 is a schematic partial perspective view of a connection structure section applicable to the electrical equipment module according to the second embodiment. FIG. 8 is a schematic cross-sectional view of the connection structure section applicable to the electrical equipment module according to the second embodiment. FIG. 9 and FIG. 10 are partial perspective views including a standby connector applied to the electrical equipment module according to the second embodiment. The electrical equipment module according to the second embodiment differs from that according to the first embodiment in main line module configuration. Hereinafter, constituents equivalent to those of the foregoing embodiment are given the same reference symbols, and in addition, redundant description of configurations, operations, and advantageous effects that are the same as those in the foregoing embodiment will be omitted to the utmost. Incidentally, FIG. 5 illustrates the instrument panel with an alternate long and two short dashes line to make the main line module of the electrical equipment module easily understandable.

An electrical equipment module 201 according to the present embodiment illustrated in FIG. 5 includes a main line module 202, the submodule 3, and the communication control connector 4 (refer to FIG. 1). In other words, the electrical equipment module 201 differs from the foregoing electrical equipment module 1 in including the main line module 202 in place of the foregoing main line module 2. The electrical equipment module 201 has approximately the same configurations as the foregoing electrical equipment module 1, except the configuration of the main line module 202, although slightly differing therefrom in shape and size. The main line module 202 is configured by including a width direction extending member 221 and a mounting main line section 222 provided in the width direction extending member 221.

The width direction extending member 221 is a member mounted in a vehicle V and extending along the vehicle width direction Y inside the instrument panel IP, more specifically, inside an accommodation space section SP. The width direction extending member 221 is configured with a back plane bus base 223 formed of an insulating resin material. In the above description, the width direction extending member 21 (refer to FIG. 2 and other drawings) is configured such that the air-conditioning duct 23 (refer to FIG. 2 and other drawings) doubles as a support member (instrument panel frame) of the instrument panel IP. By contrast, the width direction extending member 221 according to the present embodiment is configured with the back plane bus base 223 provided for exclusive use. The back plane bus base 223 constituting the width direction extending member 221 is configured by including a rectangular main body section 223a formed in the shape of an approximately rectangular plate along the vehicle width direction Y, and a plurality of bracket sections 223b provided so as to stand from the rectangular main body section 223a, and these are integrally formed using a resin material. Each of the plurality of bracket sections 223b is provided so as to stand approximately perpendicularly to a surface of the rectangular main body section 223a, the surface facing the front side in the vehicle longitudinal direction X. The plurality of bracket sections 223b is provided at intervals along the vehicle width direction Y in the rectangular main body section 223a. Here, there are provided four bracket sections 223b in total, that is, one at the right end of the rectangular main body section 223a in the vehicle width direction Y, one at the left end thereof, and two in the middle portion thereof. In other words, the back plane bus base 223 according to the present embodiment is formed in such a manner that the bracket section 223b at the right end in the vehicle width direction Y, the bracket section 223b at the left end in the vehicle width direction Y, and the rectangular main body section 223a are integrated to form an approximately U-shape, and furthermore, between the bracket section 223b at the right end and the bracket section 223b at the left end, additional two bracket sections 223b are integrally formed. Each of the bracket sections 223b has a fixing bracket 223c at an end portion thereof, and the fixing brackets 223c are each fixed to a wall surface of the body BO on the front side in the vehicle longitudinal direction X by bolts 223d or the like. The back plane bus base 223 is configured such that, with each of the fixing brackets 223c fixed to the body BO, the rectangular main body section 223a extends inside the instrument panel IP from the right end to the left end thereof along the vehicle width direction Y.

Incidentally, the back plane bus base 223 constituting the width direction extending member 221 according to the present embodiment also function as an accommodation member for accommodating an air-conditioning duct AD between the back plane bus base 223 and the wall surface of the body BO on the front side in the vehicle longitudinal direction X. The air-conditioning duct AD has approximately the same configuration as the foregoing back plane bus base 223 although differing therefrom in shape, and is a member that is formed in a hollow shape and inside which air is allowed to be circulated.

The mounting main line section 222 is provided in the width direction extending member 221, includes a circuit body 225 mounted with the electronic components 24, and is connected to the submodule 3. The mounting main line section 222 according to the present embodiment is configured in a surface (typically, the largest surface) of the rectangular main body section 223a of the back plane bus base 223 constituting the width direction extending member 221, the surface facing the rear side in the vehicle longitudinal direction X, in other words, a surface thereof opposite to the surface provided with the plurality of bracket sections 223b. In the mounting main line section 222, the surface of the rectangular main body section 223a which surface is opposite to the surface provided with the plurality of bracket sections 223b functions as a mounting surface 222a for the electronic components 24. Here, the circuit body 225 is provided in the mounting surface 222a, and the electronic components 24 are mounted so as to be connected to the circuit body 225, whereby the mounting main line section 222 becomes a back plane bus as a whole. In the mounting main line section 222 according to the present embodiment, on a surface of the width direction extending member 221, more specifically, on the mounting surface 222a of the rectangular main body section 223a of the back plane bus base 223 constituting the width direction extending member 221, a wiring pattern (print pattern) serving as the circuit body 225 is printed using a conductive material such as copper to form a printed circuit body. In other words, here, the circuit body 225 is a printed circuit body printed on the mounting surface 222a, and the electronic components 24 are mounted thereon via through holes or the like. The circuit body 225 electrically connects a plurality of the electronic components 24, and constitutes a circuit having a required function.

The mounting main line section 222 is configured with the electronic components 24, the circuit body 225, and the back plane bus base 223 so as to become a back plane bus as a whole, having an integral structure into which a function of a main line to which the submodule 3 is connected, a function of distributing power to the submodule 3 connected to the main line, and other functions are integrated. In other words, it can be said that the mounting main line section 222 is configured such that the functions of what is called an electrical connection box are incorporated into a main line. Furthermore, the mounting main line section 222 may be configured with the electronic components 24, the circuit body 225, and the back plane bus base 223 so as to become a back plane bus as a whole, having an integral structure into which functions of various ECUs, a power supply backup function, a wireless communication function, and other functions are integrated. In other words, it can be said that the mounting main line section 222 is an electronic component unit configured such that a main line to be connected to the submodule 3 is configured with the electronic components 24, the circuit body 225, and the back plane bus base 223 so as to become a back plane bus, thereby having no wire harness (no electric wire), and, into the main line in the form of a back plane bus, various functions, such as power supply distribution, control of various sections, power supply backup, and wireless communication, are integrated. The main line module 202 according to the present embodiment is configured such that the circuit body 225 is printed on a surface of the back plane bus base 223 constituting the width direction extending member 221 to be configured as a printed circuit body, whereby the width direction extending member 221 and the mounting main line section 222 can be integrally configured.

The electronic components 24 mounted in the mounting main line section 222 are various elements for performing the foregoing various functions, and including various functional components. As is the case with the above, the electronic components 24 include at least one of a connection functional component, a power supply distribution functional component, a power supply backup functional component, and a wireless communication functional component. FIG. 5 illustrates the electronic components 24 mounted in the mounting main line section 222, including, for example, connection functional components such as a connection structure section 24e and an external connection unit 24f, power supply distribution functional components such as a power supply control box 24g, control functional components such as an ECU 24h, power supply backup functional components such as a secondary battery unit 24i, and wireless communication function components such as a transceiver unit 24j. Furthermore, the electronic components 24 mounted in the mounting main line section 222 may include, for example, a function expansion unit post-installed in the connection structure section 24e, and a reading slot 241 illustrated in FIG. 6 into which a storage medium card for function expansion 24k is inserted to read data. Examples of functions added by the function expansion unit and the storage medium card for function expansion 24k include a vehicle interior monitoring (security) function, an event data recording function, and a driving support function, but the functions are not limited to these. Thus, the electrical equipment module 201 can improve function expandability, thereby allowing easy addition of functions desired by users such as drivers. Furthermore, for example, in the case where a higher density circuit such as the power supply control box 24g is required, various electronic components 24 may be mounted on the circuit body 225 in such a manner that the electronic components 24 are mounted on a printed circuit board different from the mounting main line section 222 and the printed circuit board is connected to the connection structure section 24e or the like. Furthermore, the electronic components 24 may be configured such that functional components having different specifications according to a vehicle type or the like are configured on the foregoing printed circuit board different from the mounting main line section 222 and configured to be suitably replaceable according to a vehicle type or the like.

Here, more specifically, the connection structure section 24e according to the present embodiment includes a protruding section 24ea protruding from the mounting surface 222a of the back plane bus base 223 constituting the mounting main line section 222, as illustrated in FIG. 7 and FIG. 8. The protruding section 24ea is formed in the shape of a frustum of a quadrangular pyramid having an approximately rectangular bottom, and the circuit body 225 is printed and provided as a printed circuit body on the surface of the protruding section 24ea. The connection structure section 24e is configured with the protruding section 24ea and the circuit body 225 provided in the surface of the protruding section 24ea so as to be substitutable for what is called a common male connector, and more specifically, the circuit body 225 provided in the surface of the protruding section 24ea is configured to be substitutable for a male terminal provided in a common male connector. The electronic component 24 to be connected to the connection structure section 24e is provided with a female connector 24ec including a female terminal 24eb; the protruding section 24ea is positioned so as to be fitted into and sandwiched by the female terminal 24eb; and the female terminal 24eb is electrically connected to the circuit body 225 provided in the surface of the protruding section 24ea, whereby the electronic component 24 is electrically connected to the connection structure section 24e. This allows the achievement of a connection structure without a male terminal in the connection structure section 24e, thereby allowing a reduction in manufacturing cost.

Incidentally, in the electrical equipment module 201, a common connector may be applied in place of the foregoing connection structure section 24e. In this case, the connector can be configured so as to allow the electronic components 24 to be suitably added as necessary at a reduced manufacturing cost, for example, by providing many connectors having a type in common.

As is the case with the foregoing mounting main line section 22, the mounting main line section 222 constituting the main line module 202 may be electrically connected to other vehicle-mounted modules in an engine compartment. In this case, as illustrated in FIG. 5, FIG. 9, and FIG. 10, the mounting main line section 222 is configured such that the circuit body 225 serving as a printed circuit body is provided so as to extend from the mounting surface 222a to the outside surface of the bracket section 223b at the right end in the vehicle width direction Y and the outside surface of the bracket section 223b at the left end in the vehicle width direction Y. Furthermore, the mounting main line section 222 is configured such that the circuit body 225 provided to extend to the outside surface of each of the bracket sections 223b is electrically connected to an end connector 223e provided at an end portion on the fixing bracket 223c side of each of the bracket sections 223b. Furthermore, the end connector 223e is electrically connected to a stand-by connector CO connected to an end portion of an electric wire W of each of the other vehicle-mounted modules in the engine compartment, whereby the mounting main line section 222 is electrically connected to the other vehicle-mounted modules. Thus, in the electrical equipment module 201, the back plane bus base 223 constituting the main line module 202 is provided, and besides, the end connector 223e is connected to the stand-by connector CO so that the mounting main line section 222 is allowed to be connected to other vehicle-mounted modules in the engine compartment, and accordingly, the mountability can be further improved. Incidentally, the stand-by connector CO is preferably configured so as to be, for example, provided in an end portion of the electric wire W positioned on the accommodation space section SP side via a through hole HO formed in the wall surface of the body BO on the front side in the vehicle longitudinal direction X; and temporarily fixed to a predetermined portion on the accommodation space section SP side; and released from the temporary fixing and supported by the end connector 223e at the same time the end connector 223e is completely fitted. This allows the electrical equipment module 201, for example, to prevent an excessive force from acting between connection terminals of the end connector 223e and the stand-by connector CO even if a displacement in the position of the temporarily fixed stand-by connector CO or the like according to tolerance is caused.

In the foregoing electrical equipment module 201, the main line module 202 is configured by providing the width direction extending member 221 with the mounting main line section 222 having an integral structure obtained by integrating a function as a main line connected to the submodule 3 and a function of power supply distribution, by the electronic components 24 and the circuit body 225. Furthermore, the main line module 202 and the submodule 3 are mounted to the vehicle V and connected to each other, whereby the electrical equipment module 201 can be mounted to the vehicle V. As a result, the electrical equipment module 201 allows the work of main line routing or the like to be reduced and mounting work to be made more efficient, thereby improving the mountability to the vehicle V. Furthermore, in the electrical equipment module 201, various electronic components 24 are mounted on the mounting main line section 222 of the main line module 202, whereby the main line module 202 has a simplified form and a more compact and space-saving configuration, and thus, the workability of assembly can be improved and the number of constituent components can be reduced, whereby manufacturing efficiency can be improved.

Furthermore, in the foregoing electrical equipment module 201, the width direction extending member 221 is configured with the back plane bus base 223 formed of a resin material. Therefore, in the electrical equipment module 201, the provision of the mounting main line section 222 to the back plane bus base 223 configured as the width direction extending member 221 allows the main line module 202 to be configured with, for example, an exclusive component different from a structure typically mounted to the vehicle V, whereby the electrical equipment module 201 can be mounted to various types of vehicles, thereby increasing the versatility.

Furthermore, in the foregoing electrical equipment module 201, the circuit body 225 includes a printed circuit body printed on the surface of the width direction extending member 221, herein, the surface of the back plane bus base 223. Therefore, in the electrical equipment module 201, the back plane bus base 223 constituting the width direction extending member 221 and the mounting main line section 222 are integrally configured, and accordingly, the number of constituent components can be reduced. Thus, the electrical equipment module 201 can, for example, achieve further improvement in the mountability to the vehicle V and a reduction in manufacturing costs.

It should be noted that the electrical equipment modules according to the foregoing embodiments of the present invention are not limited to the foregoing embodiments, and can be modified in various manners within the scope described in the claims. The electrical equipment modules according to the foregoing embodiments may be configured by suitably combining the constituents of the foregoing embodiments and modification.

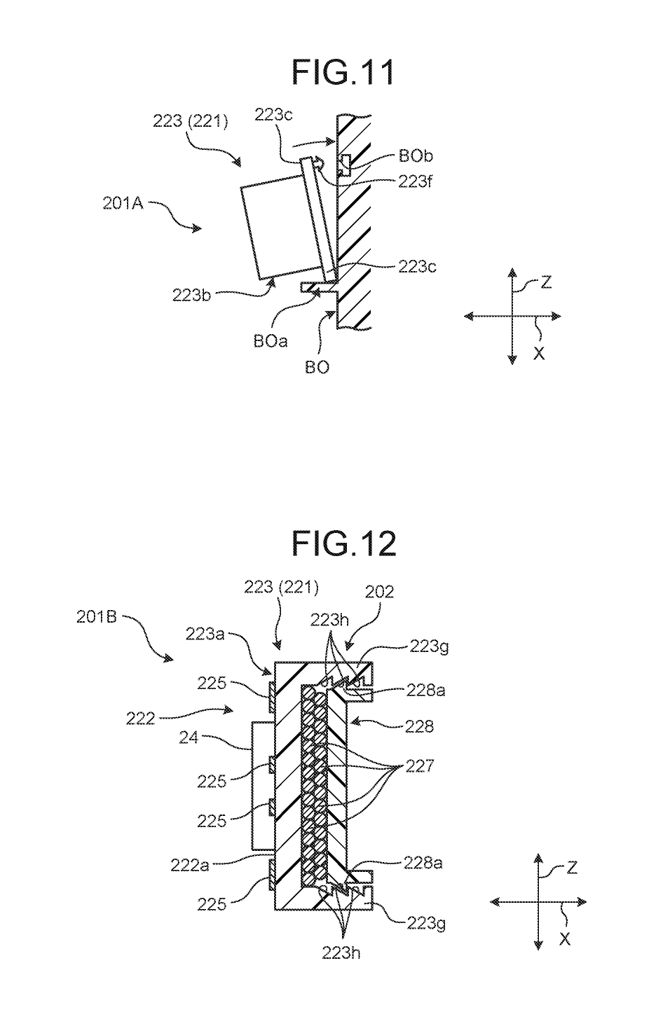

FIG. 11 is a schematic cross-sectional view including a fixing clamp of an electrical equipment module according to a modification. FIG. 12 is a schematic cross-sectional view including a rear cover of the electrical equipment module according to the modification.

The foregoing back plane bus base 223 constituting the width direction extending member 221 was described as being fixed to the wall surface of the body BO on the front side in the vehicle longitudinal direction X by the bolts 223d or the like, but is not limited to this. As illustrated in FIG. 11, the back plane bus base 223 provided in the electrical equipment module 201A according to the modification may be fixed to the wall surface of the body BO on the front side in the vehicle longitudinal direction X, for example, by a fixing clamp 223f provided in the fixing bracket 223c of the bracket section 223b on the upper side in the vehicle height direction Z. In this case, the back plane bus base 223 may be fixed to the wall surface of the body BO in such a manner that the fixing bracket 223c of the bracket section 223b on the lower side in the vehicle height direction Z is placed on a mounting stand BOa protruding from the wall surface of the body BO on the front side in the vehicle longitudinal direction X, and the fixing clamp 223f is inserted and engaged in an engaging recess BOb formed in the wall surface of the body BO on the front side in the vehicle longitudinal direction X. In this case, the electrical equipment module 201A according to the present the modification allows the main line module 202 including the back plane bus base 223 constituting the width direction extending member 221 to be mounted to the wall surface of the body BO through one action, and thus, the mountability can be further improved.

The foregoing mounting main line sections 22 and 222 were described as being configured such that the main line to be connected with the submodule 3 is made into a substrate or a back plane bus, thereby having no wire harness (no electric wire), but the mounting main line sections 22 and 222 are not limited to this, and only required to be configured so as to include at least the respective circuit bodies 25 and 225 mounted with the electronic components 24. For example, as illustrated in FIG. 12, the main line module 202 included in the electrical equipment module 201B may be provided additionally with electric wires 227 serving as a main line configured to be electrically connected to the submodule 3 (refer to FIG. 5 and other drawings). In the example illustrated in FIG. 12, the main line module 202 included in the electrical equipment module 201B includes a rear cover 228 serving as a wire holder for holding the electric wires 227 between the rear cover 228 and the back plane bus base 223 constituting the width direction extending member 221. The electric wires 227 serving as a main line are routed along the vehicle width direction Y in a surface of the rectangular main body section 223a of the back plane bus base 223, the surface being opposite to the mounting surface 222a in which the circuit body 225 and the electronic component 24 are provided (here, on the front side of the rectangular main body section 223a in the vehicle longitudinal direction X), and end portions of the electric wires 227 are electrically connected to circuit body 225 or other constituents by a connector or the like. Furthermore, in the main line module 202, the rear cover 228 is mounted to the rectangular main body section 223a of the back plane bus base 223 on the opposite side to the mounting surface 222a (on the front side of the rectangular main body section 223a in the vehicle longitudinal direction X), thereby holding the electric wires 227 between the back plane bus base 223 and the rear cover 228. Here, the rectangular main body section 223a is formed integrally with a pair of receiving frame sections 223g extending along the vehicle width direction Y at both ends of the rectangular main body section 223a of the back plane bus base 223 in the vehicle height direction Z. The pair of receiving frame sections 223g protrudes from the rectangular main body section 223a on the opposite side to the mounting surface 222a (on the front side of the rectangular main body section 223a in the vehicle longitudinal direction X), and faces each other along the vehicle height direction Z. The rear cover 228 is formed to have a size and shape allowing the rear cover 228 to be fitted between the pair of receiving frame sections 223g. A protruding section 228a formed in each end of the rear cover 228 in the vehicle height direction Z is engaged in an engaging step section 223h formed in each of the receiving frame sections 223g, whereby the rear cover 228 is mounted to the back plane bus base 223 so as to be sandwiched by the pair of receiving frame sections 223g, and holds the electric wires 227 between the rear cover 228 and the rectangular main body section 223a. Thus, in the electrical equipment module 201B, both the circuit body 225 to be mounted with the electronic components 24 and the electric wires 227 serving as a main line can be provided and routed in the main line module 202, and the electric wires 227 are collectively held, whereby the main line module 202 can be configured. In this case, the back plane bus base 223 constituting the width direction extending member 221 functions also as a routing member for routing the electric wires 227 serving as a main line. Furthermore, in this case, in the electrical equipment module 201B, the main lines each may be used differently, for example, in such a manner that the circuit body 225 of the main lines is used as a circuit for passing relatively small currents, and the electric wires 227 of the main lines are used as a circuit for passing relatively large currents.

Incidentally, as illustrated in FIG. 12, the electrical equipment module 201B preferably has a multi-step type engaging structure in which, in the foregoing pair of receiving frame sections 223g, a plurality of the engaging step sections 223h capable of being engaged with the protruding section 228a is formed along the mounting direction of the rear cover 228 (here, the vehicle longitudinal direction X), and is preferably configured such that the rear cover 228 is engaged at a position that allows gaps between the rectangular main body section 223a of the back plane bus base 223, the electric wires 227, and the rear cover 228 to be minimized. Thus, the electrical equipment module 201B can secure an appropriate accommodation cross-sectional area corresponding to the amount of internal wires between the rectangular main body section 223a of the back plane bus base 223 and the rear cover 228; can prevent the occurrence of abnormal sounds and rattling caused by the movement of the electric wires 227; and can achieve the stabilization of engaging loads imposed on the protruding section 228a and the engaging step section 223h. Incidentally, the rear cover 228 may be further provided with a protrusion or a holding rib for more certainly holding the electric wires 227, in a surface thereof facing the rectangular main body section 223a of the back plane bus base 223.

The foregoing electrical equipment modules 1, 201, 201A, and 201B were described as being applied to a vehicle having no reinforcement, but are not limited to this, and may be applied to a vehicle having a reinforcement, for example, the respective width direction extending members may be a reinforcement made of a metal material or a resin material. Alternatively, the width direction extending members may be a support member for an interior member of the vehicle V, the member being configured separately from the air-conditioning duct 23. Alternatively, the width direction extending member may be, for example, the instrument panel IP itself, and for example, a mounting main line section may be configured in such a manner that a circuit body to be printed as a printed circuit body is provided in a surface of the instrument panel IP on the accommodation space section SP side, and an electronic component is mounted to the circuit body. Likewise, the circuit body may be configured with, for example, a printed circuit body directly printed on a surface of the casing of the air-conditioning duct 23 or the like not via the substrate 26 illustrated in FIG. 2. In this case, the casing of the air-conditioning duct 23 or the like constitutes a part of the mounting main line section.

In the above description, there are provided three submodules 3 in total, namely, the steering module 3A, the console module 3B, and the instrument panel display module 3C, but the invention is not limited to this. Furthermore, the instrument panel display module 3C was described as including the display 32 provided so as to cover the approximate entirety of the instrument panel IP in a visible range, but is not limited to this, and may be configured without the display 32. In this case, the electrical equipment module may allow information to be displayed so as to cover the approximate entirety of the instrument panel IP in a visible range, for example, by projecting an image on the instrument panel IP via a rear projector that is included in another submodule provided on the rear side of the vehicle V in the vehicle longitudinal direction X.

The foregoing electrical equipment modules 1, 201, 201A, and 201B were described as being provided with the communication control connector 4, but are not limited to this.

The foregoing electrical equipment modules 1, 201, 201A, and 201B were described as an instrument panel module arranged along the vehicle width direction Y inside the instrument panel IP of the vehicle V, but are not limited to this, and may be a vehicle-mounted module arranged in another position of the vehicle V.

In the electrical equipment module according to the present embodiments, a mounting main line section having an integral structure obtained by integrating a function as a main line to which a submodule is connected by an electronic component and a circuit body and a function of performing power supply distribution is provided in a width direction extending member, whereby a main line module is configured. The main line module and the submodule are mounted into a vehicle and connected to each other, whereby the electrical equipment module can be mounted into the vehicle. As a result, the electrical equipment module can achieve the advantageous effect of reducing the work of main line routing or the like and enhancing mounting work efficiency, thereby improving mountability into vehicles.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electrical equipment module comprising:
a main line module that includes a width direction extending member mounted in a vehicle and extending along a vehicle width direction of the vehicle, and a mounting main line section provided in the width direction extending member and including a circuit body mounted with an electronic component; and
a submodule that is connected to the main line module and to which power is distributed via the circuit body.

2. The electrical equipment module according to claim 1, wherein
the width direction extending member is configured with an air-conditioning duct that has a hollow shape and inside which air is allowed to be circulated.

3. The electrical equipment module according to claim 1, wherein
the width direction extending member is configured with a support member for supporting an interior member of the vehicle.

4. The electrical equipment module according to claim 3, wherein
the width direction extending member is configured with a back plane bus base formed of a resin material.

5. The electrical equipment module according to claim 1, wherein
the circuit body includes a printed circuit body printed on a surface of the width direction extending member.

6. The electrical equipment module according to claim 1, further comprising:
a communication control connector configured to electrically connect the submodule and the mounting main line section, to perform communication between the submodule and the mounting main line section, and to control a device included in the submodule.

7. The electrical equipment module according to claim 1, wherein
the electronic component includes at least one of a connection functional component for connection to the submodule, a power supply distribution functional component for distributing power to the submodule, a control functional component for controlling a device mounted in the vehicle, a power supply backup functional component for backing up a power supply mounted in the vehicle, and a wireless communication functional component for performing wireless communication.

8. The electrical equipment module according to claim 1, wherein
the main line module is arranged inside an instrument panel of the vehicle, and
the submodule includes an instrument panel display module having a display configured to cover the instrument panel and be capable of visually displaying information.

9. The electrical equipment module according to claim 2, wherein
the width direction extending member is configured with a support member for supporting an interior member of the vehicle.

10. The electrical equipment module according to claim 2, wherein
the circuit body includes a printed circuit body printed on a surface of the width direction extending member.

11. The electrical equipment module according to claim 3, wherein
the circuit body includes a printed circuit body printed on a surface of the width direction extending member.

12. The electrical equipment module according to claim 4, wherein
the circuit body includes a printed circuit body printed on a surface of the width direction extending member.

13. The electrical equipment module according to claim 2, further comprising:
a communication control connector configured to electrically connect the submodule and the mounting main line section, to perform communication between the submodule and the mounting main line section, and to control a device included in the submodule.

14. The electrical equipment module according to claim 3, further comprising:
a communication control connector configured to electrically connect the submodule and the mounting main line section, to perform communication between the submodule and the mounting main line section, and to control a device included in the submodule.

15. The electrical equipment module according to claim 4, further comprising:
a communication control connector configured to electrically connect the submodule and the mounting main line section, to perform communication between the submodule and the mounting main line section, and to control a device included in the submodule.

16. The electrical equipment module according to claim 5, further comprising:
a communication control connector configured to electrically connect the submodule and the mounting main line section, to perform communication between the submodule and the mounting main line section, and to control a device included in the submodule.

17. The electrical equipment module according to claim 2, wherein
the electronic component includes at least one of a connection functional component for connection to the submodule, a power supply distribution functional component for distributing power to the submodule, a control functional component for controlling a device mounted in the vehicle, a power supply backup functional component for backing up a power supply mounted in the vehicle, and a wireless communication functional component for performing wireless communication.

18. The electrical equipment module according to claim 3, wherein
the electronic component includes at least one of a connection functional component for connection to the submodule, a power supply distribution functional component for distributing power to the submodule, a control functional component for controlling a device mounted in the vehicle, a power supply backup functional component for backing up a power supply mounted in the vehicle, and a wireless communication functional component for performing wireless communication.

19. The electrical equipment module according to claim 4, wherein
the electronic component includes at least one of a connection functional component for connection to the submodule, a power supply distribution functional component for distributing power to the submodule, a control functional component for controlling a device mounted in the vehicle, a power supply backup functional component for backing up a power supply mounted in the vehicle, and a wireless communication functional component for performing wireless communication.

20. The electrical equipment module according to claim 5, wherein
the electronic component includes at least one of a connection functional component for connection to the submodule, a power supply distribution functional component for distributing power to the submodule, a control functional component for controlling a device mounted in the vehicle, a power supply backup functional component for backing up a power supply mounted in the vehicle, and a wireless communication functional component for performing wireless communication.
